(19) United States
(12) Patent Application Publication
(10) Pub. No.: US 2011/0097083 A1
(43) Pub. Date: Apr. 28, 2011

(54) Data center optical network

(75) Inventor: Todd Barrett, San Diego, CA (US)

(73) Assignee: Trex Enterprises Corp.

(21) Appl. No.: 12/924,963

(22) Filed: Oct. 7, 2010

Related U.S. Application Data
(63) Continuation-in-part of application No. 12/653,723, filed on Dec. 17, 2009.
(60) Provisional application No. 61/278,425, filed on Oct. 7, 2009.

(51) Int. Cl. H04J 14/02

(52) U.S. Cl. 398/48

(57) ABSTRACT

A new networking architecture for data centers, storage networks, and parallel computer centers. This invention eliminates the need for the large complicated core. In essence we replace the large complicated M×M switches at the core of the data center network with simple 1×N (where N is the total number of servers in the data center) switch at every server. Physically, we take advantage of the fact that a single optical fiber can carry thousands of high-bandwidth communications channels to enable the construction of 1×N switches that are roughly equivalent in cost and complexity to a single optical transponder unit.

### CROSS REFERENCE TO RELATED APPLICATIONS

The present invention is a continuation in part of U.S. patent application Ser. No. 12/653,723 filed Dec. 17, 2009, and this application claims the benefit of Provisional Patent Application Ser. No. 61/278,425.

### FERERALLY SPONSORED RESEARCH

The present invention was conceived in the course of performance of Contract Number NRO 000-09C-0133 with the United States Department of Defense and the United States Government has rights in the invention.

### FIELD OF THE INVENTION

The present invention relates to high speed optical networks and in particular to high speed optical networks for data centers.

### BACKGROUND OF THE INVENTION

Current data centers provide networking between individual hosts or servers in the data center using large and complicated Ethernet, Fiber-Chanel or other similar switches. FIG. 1 shows the architecture commonly used in these facilities. These data centers typically comprise a storage area network, referred to as SAN in the drawing, which utilizes a core of big switches such as 200×200 port or 400×400 port switches to connect a large number of servers. Commonly, data center servers are networked by means of complicated hardware dedicated to switching. Often traffic from several individual servers is combined into a single channel in the “aggregation layer” as shown in FIG. 1. In the network core the large, expensive switches with high bandwidth ports are used to route the information to the correct destination.

What is needed is a better networking architecture for data centers and similar facilities.

### SUMMARY OF THE INVENTION

The current invention provides a new networking architecture for data centers, storage networks, and parallel computer centers. This invention eliminates the need for the large complicated core. In essence we replace the large complicated M×M switches at the core of the data center network with simple 1×N (where N is the total number of servers in the data center) switch, one at every server. Physically, we take advantage of the fact that a single optical fiber can carry thousands of high-bandwidth communications channels to enable the construction of 1×N switches that are roughly equivalent in cost and complexity to a single optical transponder unit.

### BRIEF DESCRIPTION OF THE DRAWINGS

FIG. 1 architecture commonly used in data centers.

FIG. 2 shows how servers are linked together in preferred embodiments of the present invention.

FIG. 3 shows how data centers would look physically in preferred embodiments.

FIG. 4 shows a preferred star topology.

FIGS. 5, 6A and 6B show two technologies Applicant has investigated.

FIG. 7 shows a schematic representation of a server node.

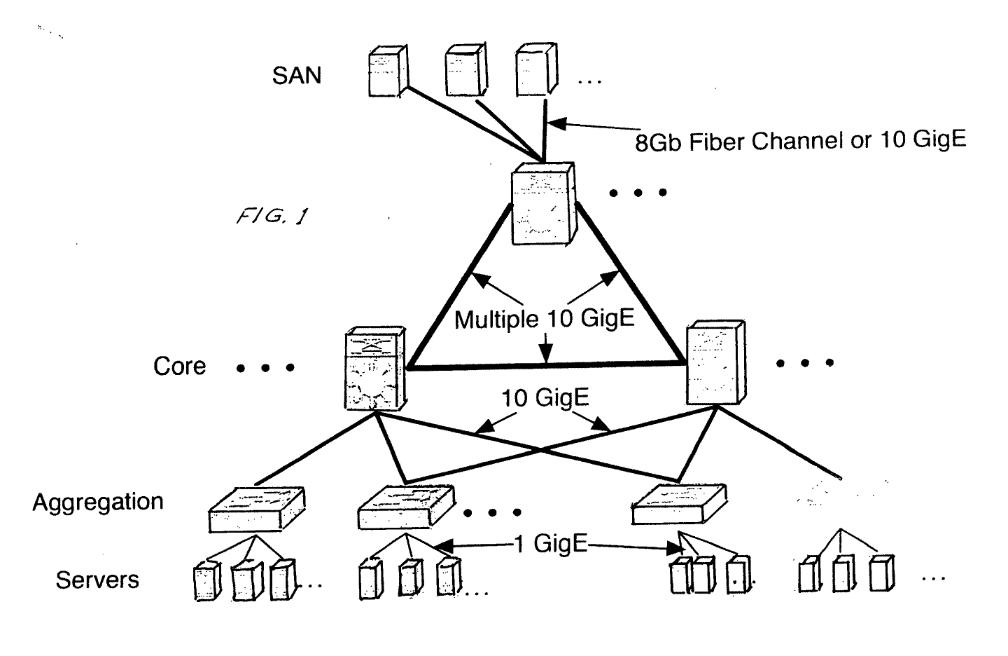

### DETAILED DESCRIPTION OF PREFERRED EMBODIMENTS

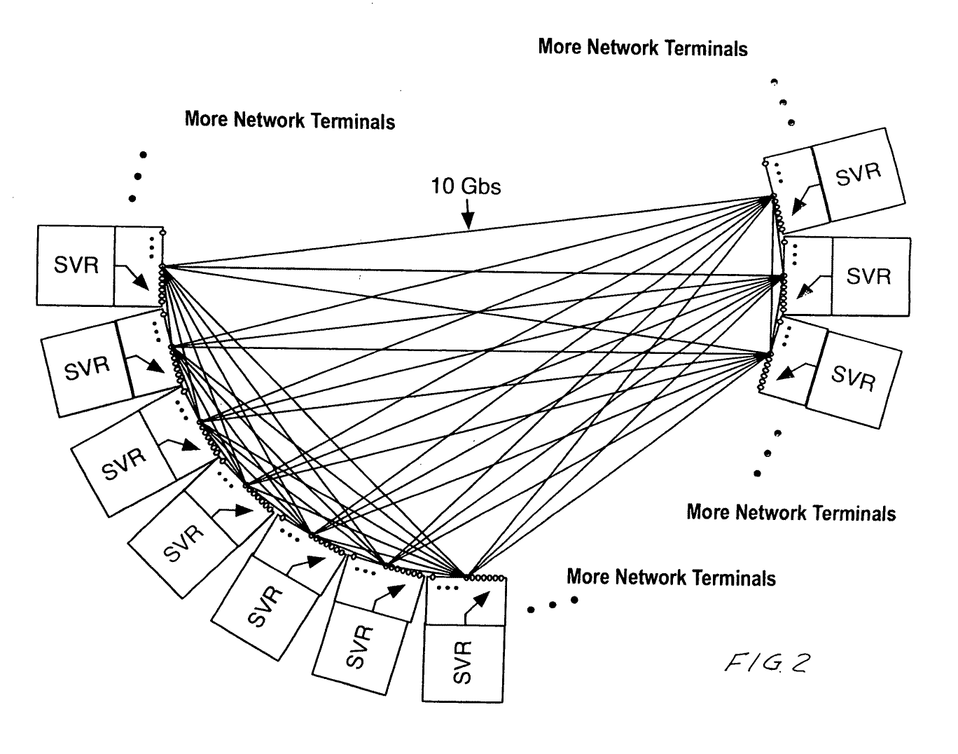

FIG. 2 shows a schematic of how the servers are linked logically. Physically, we take advantage of the fact that a single optical fiber can carry thousands of high-bandwidth communications channels to enable the construction of a communication network based on the use of 1×N switches and modulators and de-modulators associated with each 1×N switch to provide communication among hundreds or thousands of servers. Networks could include any number or servers such as: 101 servers, 1,001 servers, 10,001 servers or more. Each server is connected to all other servers by a 1×N switch. Preferred embodiments use the C and L band commonly used in telecommunications networks for long-haul transport. These two bands range in wavelength from 1530 nm to 1625 nm. Using only this region of the spectrum and efficient coherent modulation and demodulation techniques a single fiber can carry 3,300 10 Gbs channels, or enough information to link 6,600 computers together. So a system using a fiber plant consisting of 3 fiber pairs could be used in a data center with 19,800 servers each linked to every other server by a 10 Gbs connection.

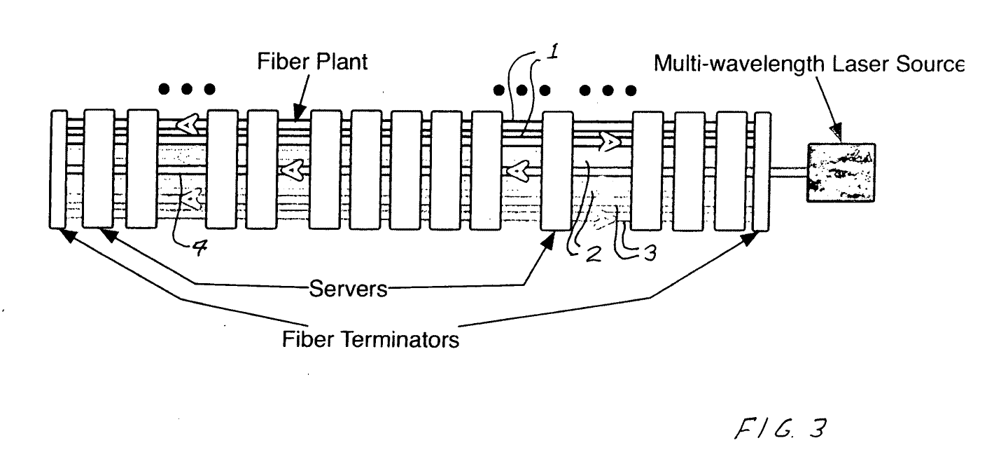

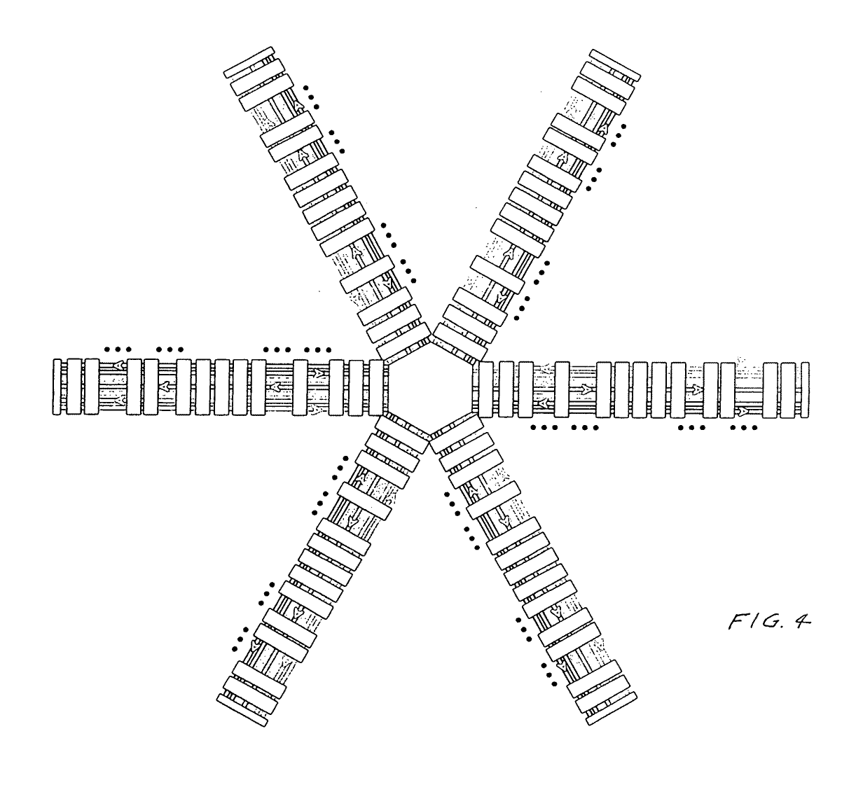

FIG. 3 shows how the data center network would look physically. It could be implemented as an array of servers communicating on a linear fiber plant. In this case all servers (up to 10s of thousands) are connected to a few fibers serially. Servers are distributed serially on the fiber plant, which consists of 1 or more counter propagating fiber pairs. A total of three pairs is shown in the diagram. These three pairs are identified as pairs 1, 2 and 3. A 7^{th} fiber, identified as 4 is used to distribute a multi-wavelength (frequency comb) laser source to the servers. This light source is used as a carrier and local oscillator in the modem located in each server. The 7 fiber plant shown in the figure could conceivably provide networking for more than 19,800 severs. Applicant estimates that a single pair would be sufficient for about 6,600 servers. For a large data center, when the number of servers gets above a several hundred a star topology as shown in FIG. 4 adds robustness, ease of cabling, flexibility in physical location of servers, and protection against taking the entire network down with a single fiber cut. The server nodes are identical to those on the linear layout, and the network functions exactly as it does in the linear layout. The signals on corresponding fibers in each branch of the star are copies (tapped and amplified at the hub). The hub contains the multi-wavelength source and the signal duplication hardware. This topology is more flexible in the cabling and server layout and will work better when the number of servers grows large or where it is advantageous to have the servers in more than one location. For example, in the case of the star topology, the servers that comprise each leg may be located in separate buildings on the same campus, or even on sites that are located 10-60 km apart.

The technical key to implementing the concept above is the 1×N switch. Applicants use a combination of novel technologies to achieve the desired performance. First it uses a multi-wavelength optical source distributed to each node via a dedicated fiber to provide a local oscillator for the coherent demodulator, and as a carrier for the modulator. A mode-locked laser can be used as the multi-wavelength light source or alternatively a bank of narrowband lasers, offset from each other by the channel spacing, can be multiplexed onto a single fiber. A portion of the source is tapped at each node, amplified, and used in the optical modem.

In order to pack as many channels as possible onto a single fiber an efficient coherent signaling scheme is used such as optical Differential Quadrature Phase Shift Keying (DQPSK). Channel separation and demodulation are done at an RF intermediate frequency, and channel selection is effected by choosing the appropriate narrow tooth of the multi-wavelength source for mixing in the coherent demodulator.

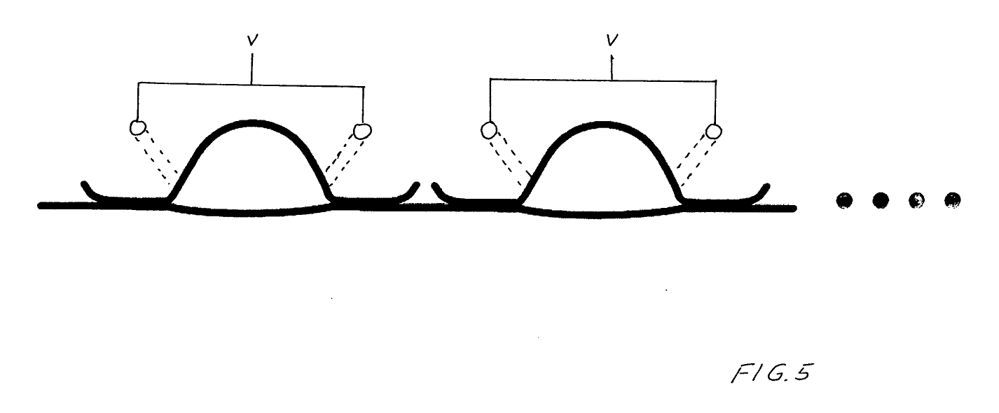

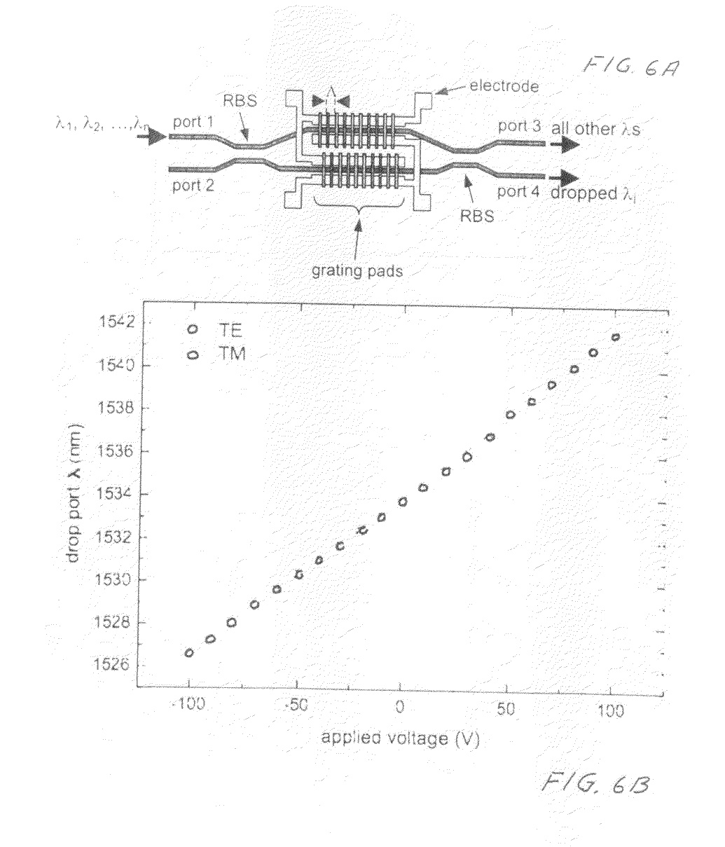

Fast wavelength switching is achieved using very fast (10 ns time scale) tunable band-pass filters. Several technologies exist for implementing such a filter. Most are implemented in an electro-optic material such as LiNbO₃. FIGS. 5 and 6 show two technologies Applicants has investigated. FIG. 5 shows two of a cascaded set of Mach-Zehnder interferometers with unbalanced legs used as a fast tunable wavelength filter. If constructed in LiNbO₃ the filter can be tuned in nano seconds. Electrodes are placed on the long leg of the interferometer to provide tune-ability. FIG. 6A shows a polarization independent device called a static strain induced Bragg grating tunable filter used in embodiments as rapidly tunable bandpass filters. Shown in FIG. 6B is tuning of the center of the bandpass region of the filter between for wavelengths between 1526 nm and 1542 nm. The potential ranges from −100 volts to +100 Volts. This device was fabricated by Shin et. al. (Shin Y., Eknoyan O., Madsen C. K., Taylor H. F., “Rapidly Tunable Optical Add Drop Multiplexer in Ti:LiNbO3 Utilizing Non-polarizing Beam Splitters,” Proceedings of the OFC/NFOEC, OWI6 2008.) The authors refer to their device as an RBS which stands for “relaxed beam splitter” and means that that the sum of the power splitting ratio for the orthogonal components of the incident light add to unity. The technology of FIGS. 6A and 6B is the preferred embodiment. Only one tunable filter per node is required and it is used to separate one tooth of the frequency comb coming from the multi-wavelength source. Because it is used to separate a narrowband spike from the comb its performance requirements are relaxed compared to what would be required for a filter that was separating a communications channel from adjacent communications channels. As mentioned above channel separation from adjacent channels is done in the IF space by fixed electronic filters.

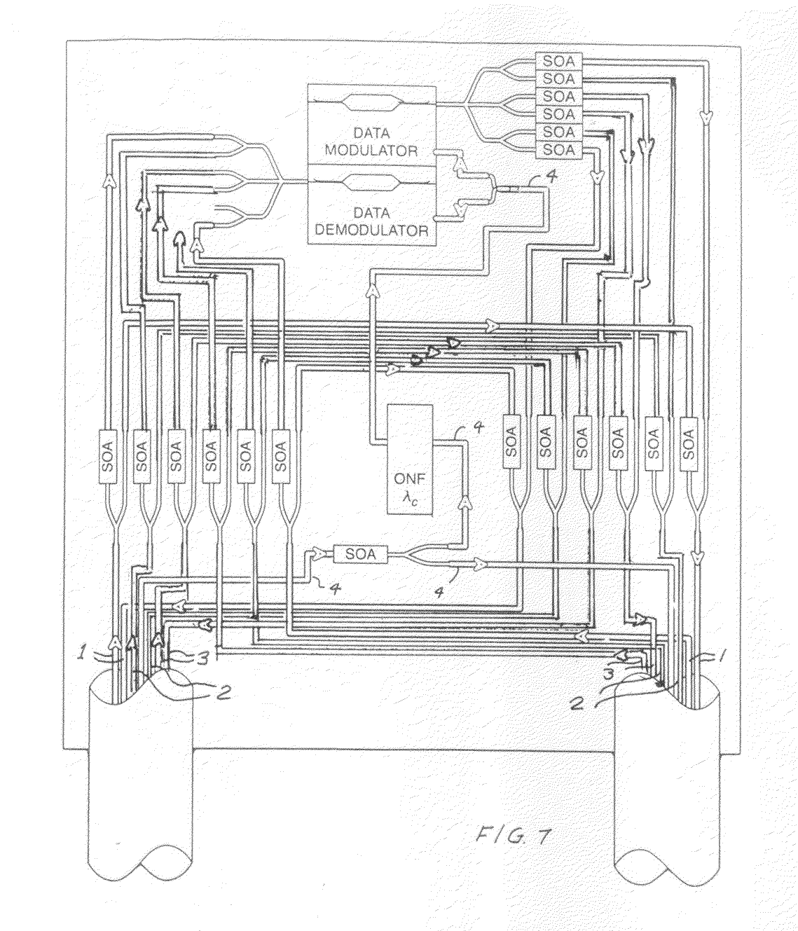

Fiber switching can be accomplished in several ways. The preferred embodiment is to use a beam combiner and a semiconductor optical amplifier (SOA). A copy of the signal from each fiber in the fiber plant is passed through its own SOA. For the fiber that carries the desired communications channel the SOA is turned on and the signal is amplified. All other SOAs are turned off and they act as an absorber. In this way approximately 60 dB of isolation is achieved and fibers can be switched very fast due to the small time constant (nano second scale) of the SOA device. FIG. 7 shows a schematic representation of a server node including the tunable filter, the SOAs, the coherent modulator and demodulator, and the fiber plant. This is a schematic drawing of a network card of a server in the present invention. The box labeled ONF is the fast tunable filter for wavelength selection. Lines 4 represent the fibers carrying the multi-wavelength source. The fiber plant enters and exits the node in the two bundles at the bottom of the diagram. The couplers and de-couplers can be implemented in either fiber or in slab waveguides. The boxes labeled SOA represent semiconductor optical amplifiers.

### Variations

The present invention has been described above in terms of certain preferred embodiments. Persons skilled in the optical communication art will recognize that many variations are possible utilizing the basic concepts of the present invention. For example, many techniques are available for modulating and de-modulating the optical signals. Other optical filters could be substituted for the ones referred to above. Many 1×N optical switches could be used in the network. Topologies other than linear and star could be utilized.

What is claimed is:

1. A low capital and operating cost, low power consuming data center optical network comprising:
A) at least 101 servers, each of said at least 101 servers comprising a tunable band-pass filter, a data modulator, a data de-modulator and a plurality of optical amplifiers,
B) at least 101 1×N optical switches, one said at least 101 1×N optical switches being in optical communication with each of said at least 101 servers and at least 100 other servers,
C) an multi-wavelength optical source in optical communication with each of said at least 101 and adapted as a local oscillator for the data modulator and the de-modulator of each of said at least 101 servers.

2. The data center optical network as in claim 1 wherein said at least 101 servers is at least 1,001 servers.

3. The data center optical network as in claim 1 wherein said at least 101 servers is at least 10,001 servers.

4. The data center optical network as in claim 1 wherein the multi-wavelength is adapted to provide a frequency comb to the at least 101 servers.

5. The data center optical network as in claim 1 wherein the at least 101 servers are arranged in a linear topology.

6. The data center optical network as in claim 1 wherein the at least 101 servers are arranged in a star topology.

7. The data center optical network as in claim 1 wherein a plurality of the tunable band-pass filters comprises Mack-Zehnder interferometers.
